(19) United States
(12) Patent Application Publication
(10) Pub. No.: US 2003/0014318 A1
(43) Pub. Date: Jan. 16, 2003

(54) INTERNATIONAL TRADING SYSTEM AND METHOD

(75) Inventors: ALAIN L. DE LA MOTTE, HILLSBORO, OR (US); CHRIS NELSON, MULINO, OR (US); BRIAN LEE BRACKINREED, TUALATIN, OR (US)

Correspondence Address: KOLISCH HARTWELL DICKINSON, MCCORMACK & HEUSER, SUITE 200, 520 SW YAMHILL STREET, PORTLAND, OR, 97204

(73) Assignee: Matthew T. Byrne

(21) Appl. No.: 09/364,711

(22) Filed: Jul. 30, 1999

Related U.S. Application Data
(63) Continuation-in-part of application No. 08/745,196, filed on Nov. 8, 1996, now abandoned.

(51) Int. Cl. G06F 17/60

(52) U.S. Cl. 705/26

(57) ABSTRACT

A system and method for facilitating transactions involving the sale of goods or services. A standardized product rating system allows the subjective characteristics of a product to be evaluated and objectively rated based on generally accepted levels of quality. The products and factories of suppliers are also evaluated and rated in accordance with the standardized rating system. In one exemplary embodiment, a network of product buyers and suppliers are connected via a computer network. Through remote terminals, buyers submit requests-for-quotes, and suppliers submit bids, both of which specify objective and subjective aspects of a product using the standardized ratings. A network of independent, third-party service providers is also provided. The third-party service providers may place bids, via the computer network, to perform services necessary to execute purchase/sales transactions between the buyer and supplier.

### CROSS-REFERENCE TO RELATED APPLICATION

This application is a continuation-in-part of U.S. patent application Ser. No. 08/745,196, filed Nov. 8, 1996 of Alain L. De La Motte for METHOD AND SYSTEM FOR FACILITATING, SELECTING, ORDERING AND PURCHASING OF PRODUCTS.

### TECHNICAL FIELD

The present invention relates generally to a system and method for conducting international transactions involving the sale of goods or services, and more particularly to an international trading network allowing buyers and suppliers to negotiate directly for the sale of goods and services.

### BACKGROUND

Traditionally, there are several approaches by which product buyers acquire the products they need, and by which suppliers find markets for their products. However, these traditional approaches involve a substantial amount of inefficiency and expense.

For example, one common approach involves a buyer developing a business relationship with a supplier over a period of time during which the parties exchange multiple communications and investigate each other's business and financial references to verify that the other is able to perform on future contracts. However, as a buyer attempts to establish trading partnerships with a number of suppliers, or a supplier attempts to establish partnerships with a number of buyers, the investment of time and expense by the parties may become prohibitive. Furthermore, since most product markets are continuously changing, it may be impossible for a buyer or supplier to maintain an up-to-date knowledge of the market.

For these reasons, many buyers and suppliers will only trade with a few partners. While this solution may offer some stability, it also limits the market in which the parties trade. For example, a buyer would forego lower prices and/or higher quality products which may be available from other suppliers. Similarly, a supplier may forgo additional sales because many buyers are unaware of the supplier's products. Thus, by restricting the market in which they trade, both buyers and suppliers may give up the opportunity to increase their profits.

Because it is expensive and time-consuming for buyers and suppliers to develop and maintain an understanding of the global product market, another common trading approach involves the use of one or more intermediaries. Similarly, buyers and suppliers who are unable or unwilling to expend the time, effort, and expense to develop a relationship with a trading partner, may also hire an intermediary such as an agent, a broker, an importer, etc., to handle each transaction. These intermediaries use their knowledge of the product market to match buyers and suppliers. They may also perform or arrange services such as quality assurance, logistics management, financing, etc. The intermediaries may collect fees or commissions for their services, or they may actually buy the products from a supplier and then resell the products to a buyer with a markup in price.

While intermediaries typically have the market information and contacts to trade products on an international scale, it is often difficult for buyers and suppliers to determine how much the intermediary is charging. This is because the intermediaries control the market information as well as the negotiations and the purchase transaction. The buyer may not know what price the supplier has agreed to accept. Likewise, the supplier may not know what price the buyer has agreed to pay. Without accurate knowledge of the product market, both buyers and suppliers may be vulnerable to unscrupulous intermediaries.

Furthermore, the use of intermediaries to handle purchasing transactions introduces substantial inefficiency into the market. Even scrupulous intermediaries charge a fee for their knowledge and labor. Thus, when a transaction or negotiation involves an intermediary between the buyer and supplier, either the buyer, the supplier, or both, will incur the cost of the intermediary's services.

Another source of inefficiency in conventional trading systems involves repetitive, redundant, and inconsistent quality assurance measurements. This is perhaps especially true where the product(s) being traded are valued based on subjective criteria as well as objective criteria. Subjective criteria are often evaluated differently between buyers and suppliers, as well as between different buyers and between different suppliers. Therefore, it can be difficult to negotiate the sale of such a product unless the buyer is able to physically inspect a sample of a supplier's product, and has some assurance that identical products from that supplier will be of approximately the same quality as the sample. Furthermore, the buyer may need some assurance that the product is produced under specific quality and/or safety standards and regulations (e.g., for food products, medical products, etc.).

Under conventional trading approaches, a buyer would have to obtain product samples from each supplier who submits a quote to evaluate the quality of the supplier's product prior to purchase. Further, the buyer may have to inspect the factories of each supplier to ensure compliance with applicable rules and regulations. Without this product-quality information, a buyer cannot rationally evaluate a supplier's quote, or compare quotes from different suppliers. Similarly, suppliers must send out numerous product samples to a number of potential buyers, and accommodate frequent and redundant inspections which interfere with the manufacturing process.

Thus, not only do conventional trading systems involve a significant cost to each party, they also cause substantial waste and inefficiency in the market as a whole. It would be desirable, therefore, to enable buyers and suppliers, wherever located, to fairly, efficiently, and knowledgeably negotiate directly among themselves for the purchase and sale of products; including products whose values are based, at least in part, on subjective criteria.

### SUMMARY OF THE INVENTION

The present invention provides a system and method for facilitating trading transactions involving the sale of products. The invention includes a standardized product rating system that allows the subjective characteristics of a product to be evaluated and objectively rated based on generally accepted levels of quality. Both the products and factories of suppliers are evaluated by an independent, quality-control measurement organization, which applies ratings to the products and factories in accordance with the standardized rating system. Thus, buyers and suppliers, wherever located, can negotiate using mutually understood descriptions of product quality to rationally value a supplier's products in comparison to those of competing suppliers.

In one exemplary embodiment of the invention, a network of product buyers and suppliers are connected via a computer network. Through remote terminals, buyers may submit requests-for-quotes (RFQ's), which specify both objective as well as subjective aspects of a product using the standardized product ratings. Also through remote terminals, suppliers may submit bids or offers, which describe their products using the standardized ratings. Buyers and suppliers may thereby negotiate the purchase and sale of products via the computer network based on objective, mutually-understood descriptions of product quality.

The invention also connects buyers and suppliers to a network of independent, third-party service providers. These third-party service providers may place bids, via the computer network, to perform services necessary to execute purchase/sales transactions between the buyer and supplier.

### BRIEF DESCRIPTION OF THE DRAWINGS

FIG. 1 is a block diagram of a trading system according to the present invention.

FIG. 2 is a block diagram of an exemplary embodiment of the trading system of FIG. 1, implemented on one or more computer systems connected to communicate via a computer network.

FIG. 3 is an exemplary quality-control report illustrating the results of product testing.

FIG. 4 is an exemplary factory audit report according to the present invention.

### DETAILED DESCRIPTION

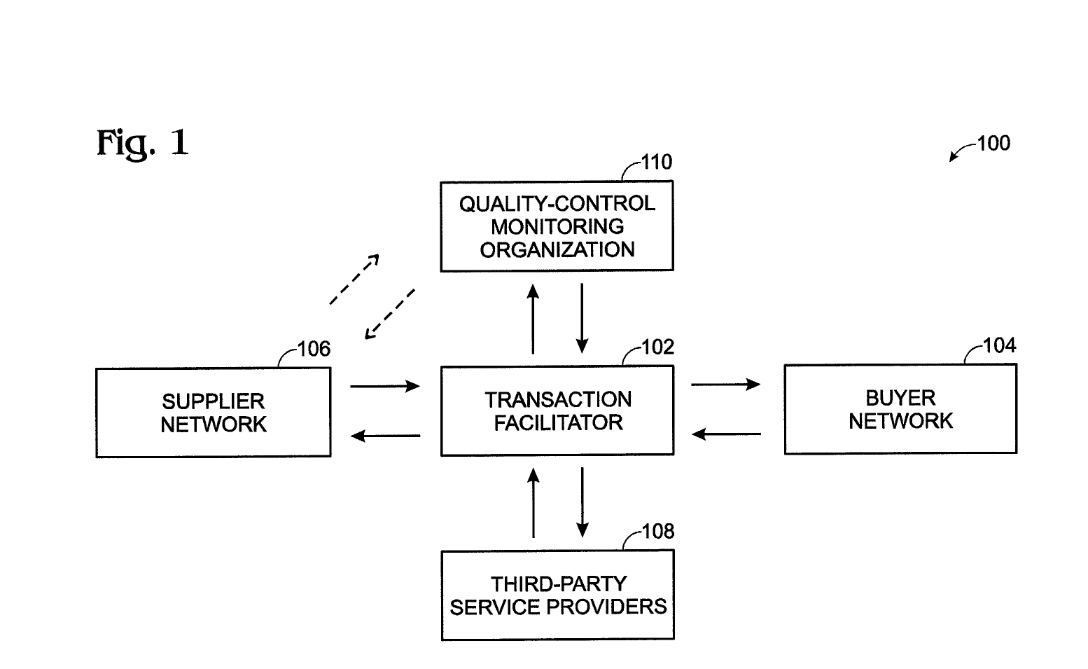

In accordance with the present invention, a system for facilitating transactions involving the sale of goods is indicated generally at 100, in FIG. 1. System 100 includes a transaction facilitator 102 connected to communicate with a network of buyers 104 and a network of suppliers 106. Transaction facilitator 102 functions to increase the efficiency of existing markets by linking buyers and suppliers of products directly rather than through one or more levels of market intermediaries. In addition, transaction facilitator 102 broadens the market participation of both buyers and suppliers by exposing them to a global network of market participants with whom to trade.

In one preferred embodiment, system 100 also includes a network of third-party service providers 108 communicatively connected to transaction facilitator 102. These third-party service providers support the primary market participants (i.e., the buyers and suppliers), by performing various tasks typically associated with the sale of goods. In conventional trading transactions, many of these third-party service providers act as intermediaries by leveraging their access to market information. However, as will be discussed in greater detail below, system 100 exposes the structure and dynamics of the market to both buyers and suppliers, thereby eliminating the need for intermediaries. Nevertheless, since buyers and suppliers may continue to require and/or desire the services provided by third-parties, system 100 provides a transactional link through which these services can be retained.

System 100 also preferably includes a quality control monitoring organization 110, which supports the trading process by providing standardized, reliable, and independent quality-control information regarding suppliers' products. This quality control information is typically expressed in the form of standardized ratings which represent relative evaluations of both objective and subjective product characteristics. The standardized product and factory ratings allow buyers and suppliers to negotiate transactions for products based on product specifications which are mutually understood and independently verified. In other words, the standardized product ratings permit the parties to compare “apples to apples,” by specifying products according a variety of relevant subjective factors as well as typical objective factors such as price and quantity, etc.

In one preferred embodiment, quality control monitoring organization 110 also provides factory audit and certification services by conducting standardized inspections of the factories of participating suppliers. As will be discussed in greater detail below, this standardized factory audit service provides buyers with assurance that the products they purchase are manufactured according to the buyer's requirements as well as according to any applicable governmental regulations.

It will be appreciated that the structural organization and methods described herein may be implemented in a variety of ways depending on such factors as the type of product involved, the size and organization of the conventional market for the product, the structural resources available, and the receptiveness of the relevant market participants to technology. Furthermore, the invention is not limited to any specific product or type of product, as the invention may be practiced in relation to a virtually unlimited array of goods and services. Therefore, while the invention is herein described in the context of an exemplary embodiment in which bulk, non-commodity food products are traded through a virtual marketplace formed by a global computer network, it will be understood that the invention is not limited to the exemplary embodiment, but includes all such implementations for trading all such goods and services.

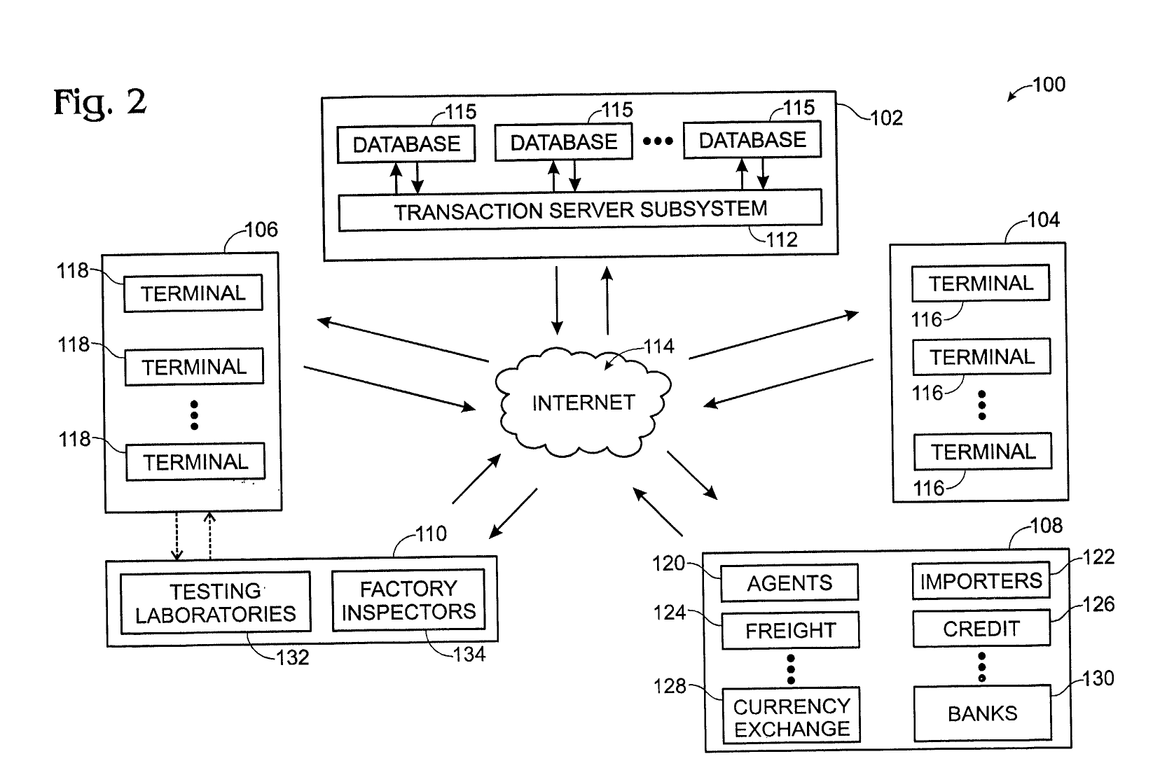

The physical interconnection of the exemplary embodiment is illustrated schematically in FIG. 2. Transaction facilitator 102 includes a transaction server subsystem 112 connected to a global computer network 114. Typically, network 114 is the Internet. Alternatively, network 114 may be any one or more of a variety of public or private, general use or dedicated electronic communications networks, including intranets, extranets, etc. Transaction server subsystem 112 may include any of the many types of computer servers well known in the art, and may be implemented on a single computer or distributed across a plurality of interconnected computer systems. Transaction facilitator 102 also includes databases 115, which will be described in more detail below. While databases 115 are shown as multiple databases, it will be appreciated that the databases may alternatively be a single database maintained on one or more computer systems. In any event, the transaction server subsystem is configured to access the databases and to selectively present information contained in the databases to the buyers, suppliers, etc.

Buyer network 104 and supplier network 106 include a plurality of buyer terminals 116 and supplier terminals 118, respectively, which are connected to communicate with transaction server subsystem 112 via the Internet. Terminals 116 and 118 are typically owned and/or operated by each buyer and supplier, and may be a personal computer, a laptop computer, a personal digital assistant (PDA), a set-top-box, or any other suitable device for exchanging data over a computer network.

Similarly, the network of third-party service providers 108 includes a plurality of terminals (not shown) which are connected to communicate with the transaction server subsystem via the Internet. Typical third-party service providers include, but are not limited to, agents 120, importers 122, freight carriers 124, credit agencies 126, currency exchangers 128, banks 130, and etc.

Finally, quality control monitoring organization 110 includes both testing laboratories 132 and factory inspectors 134. Testing laboratories 132 perform quality control measurements of sample products which are sent to the laboratories from the suppliers'factories. Factory inspectors 134 perform on-site inspections of the factories themselves. Preferably, both the testing laboratories and the factory inspectors are also connected to communicate with the transaction server subsystem via the Internet. Alternatively, one or both communicate their results to a single entity (not shown) within the quality control monitoring organization, which then relays the information to the transaction server subsystem.

The Internet connections of the transaction facilitator and the various terminals used by the buyers, suppliers, etc., may be any of the well known interconnection technologies such as modem, cable, Ethernet, fiber-optic, or etc. The communications protocols between the transaction facilitator and the various participants may be standard TCP/IP protocol suites or other protocols for transferring data over a computer network. In addition, many of the features and methods described herein may be implemented at least partially by software running on the transaction server subsystem and/or one or more of the remote terminals.

Preferably, each buyer, supplier, and third-party service provider gains access or “membership” to system 100 by registering with the system operator. The system operator typically will collect information regarding the identity of the participant, the party's financial information, the goods/services in which the participant trades, and etc. This information may be stored in one or more databases 115 of transaction facilitator 102 for access by transaction server subsystem 112. In addition, some or all of the information may be made accessible to other participants, or members, via the transaction server subsystem. Thus, for example, a supplier can review the credit history of a buyer, or the references of a freight carrier by accessing the appropriate database 115. Preferably, appropriate security measures are implemented to prohibit unauthorized users from accessing system 100. Exemplary security measures include password/login procedures and encrypted network communications.

In one preferred embodiment, registered companies may designate multiple employees or agents as authorized buyers, etc., for the company. These employees may be authorized to trade in a variety of products or only a single product. In either event, the identification of an individual's area of responsibility allows the trade facilitator to target relevant advertisements, promotions, and other information to the appropriate individual in an organization.

As illustrated in the exemplary embodiment depicted in FIGS. 1 and 2, system 100 provides a virtual marketplace for negotiating and executing sales of food products. Remote buyers can develop RFQ's defining both the objective configurations (i.e., product type, package size, quantity, delivery requirements, etc.) and subjective characteristics (i.e., flavor, aroma, texture, etc.) of the product. The buyer then sends the RFQ to the transaction facilitator for presentation to suppliers located throughout the world. In response, interested suppliers may develop quotations (also referred to herein as quotes or bids) to provide the product specified in the RFQ for a particular price. The suppliers' bids are sent to the transaction server subsystem for presentation to the buyer, who may accept a bid or make a counter-offer. Since both the RFQ and the bids describe the product according to the standardized product ratings, buyers are assured that the products they receive are the products they expect, while suppliers are assured that all competing suppliers are bidding on the same quality of product.

In addition to responding to specific RFQ's, suppliers may also submit bids or offers to sell products to the transaction server subsystem for presentation to likely interested buyers throughout the world. In the exemplary embodiment, a virtual “trading floor” is established in a database 115 accessible via the transaction server subsystem. Registered buyers can “shop” the trading floor by accessing the database in which the quotes are stored and “browsing” through the quotes for products in which they are interested. Additionally, buyers can activate software filters to screen offers based on product type, supplier, country of origin, etc. When a buyer finds an offer of interest, the buyer can either accept the offer or submit a counter-offer for presentation to the supplier.

Once a buyer and supplier have reached agreement on the terms of sale, the transaction may be published to third-party service providers who can then bid to provide any services necessary to execute the transaction. Alternatively, the buyer and supplier can submit RFQ's to service providers for needed services. In any event, the system is preferably organized so that the third-party service providers are not able to interfere with the direct negotiations between buyers and suppliers.

In the exemplary embodiment, transaction facilitator 102 is configured to maintain a database 115 of product RFQ's, bids, and sales for review by the system members. Using the information in this database, the transaction facilitator can generate a price history for a particular product, showing historical pricing trends based on a variety of variables including product quality, season, supplier, region of origin, etc. Thus, both buyers and suppliers have immediate access to the kind of market information that is reserved to the intermediaries of conventional trading systems. The system thus exposes the underlying global market to empower buyers and suppliers to negotiate trades without the interference and inefficiency of intermediaries.

To ensure unimpeded access to the global product market, the transaction facilitator also provides language translation capability for both incoming and outgoing communications. Each member can designate its own interface language. Thus, for example, a buyer in the United States could prepare an RFQ in English, which is then translated into French for presentation to a potential supplier in France. That supplier could then prepare and submit a bid in French, which is translated into English for presentation to the buyer. Once the purchase agreement is published, a Japanese freight carrier may submit a bid in Japanese to transport the product from the supplier's factory in France to the buyer in the United States. The freight carrier's bid may be translated into either English or French, depending on whether the buyer or supplier is responsible for arranging to ship the product. For clarity, the examples described herein assume that no language translation is needed.

Focusing now on the operational flow and organization of the exemplary embodiment, after registration and login, a buyer is ready to develop an RFQ. Preferably, the buyer terminal displays a list of food product descriptions from which the buyer may select or “shop.” The food product descriptions are maintained on a database 115 accessible via transaction facilitator 102, and are transmitted to the buyer terminal over the Internet.

Each product description typically includes a product configuration and a product specification, each of which usually has several components. The product configuration identifies the type of product and the way in which the product is configured for sale. The product configuration includes objective characteristics or components such as product name, product size, packaging, labeling, etc. In contrast, the product specification includes information defining the relative quality of the product. The components of the product specification are one or more subjective characteristics associated with a particular product. Typically, the product characteristics are defined in the product specification in terms of a minimum rating. As will described in more detail below, a product having a particular characteristic with a higher rating than required in the product specification would be considered as meeting the specification. In any event, the function of the product characteristics is to specify a predefined and verified level of quality for the food product.

Preferably, the buyer defines a suitable product description by selecting the desired components of the product configuration and product specification from a list of possible components which are displayed on the buyer terminal. For the components of the product configuration, the buyer typically selects from a list of commonly available quantities, package sizes, etc. Alternatively, the buyer might specify one or more components in a non-standard size, package, etc. Similarly, for the components of the product specification, the buyer typically selects from a list of standardized product-quality component ratings to indicate a desired level of quality. Alternatively, the buyer might specify a non-standard product-quality component.

Once the product description is defined, the buyer finalizes the RFQ by providing additional information such as delivery date, delivery method, delivery location, country of origin, invoice terms, whether samples are required, and etc. The information is transmitted from the buyer terminal to the transaction facilitator which formats the information into a standard RFQ. The buyer can review the RFQ and, if acceptable, submit it to the transaction facilitator for presentation to suppliers. The buyer may also specify a response time within which bids must be received to be considered. The transaction facilitator may assign some identifying label to the RFQ to aid in the tracking and routing of RFQ's.

Typically, the transaction server subsystem includes an RFQ module (not shown) configured to receive RFQ from buyers, store the RFQ in a database 115, and transmit the RFQ's to selected supplier terminals in the supplier network. The transaction server subsystem may send the RFQ to all member suppliers, or only to those suppliers who supply the product identified in the RFQ. In the latter case, the transaction server subsystem accesses the supplier registration database to determine which member suppliers are registered as providing the product. Alternatively, as will described in more detail below, the buyer may specify a particular supplier or factory rating to instruct the transaction server subsystem to send the RFQ only to those suppliers having the specified rating. In any event, the RFQ is sent to each of the appropriate suppliers via the Internet such as by instant messaging, e-mail, or etc.

It will be appreciated that while the RFQ is described as being “sent” or “transmitted” to some or all suppliers, the transaction server subsystem may simply post the RFQ for access by interested suppliers. The suppliers may then access the RFQ in the course of a periodic review of outstanding RFQ's, or in response to a message announcing the new RFQ.

In the embodiment just described, the buyer submits an RFQ for presentation to a plurality of suppliers, whether known or unknown by the buyer. Thus, the buyer can choose among products from suppliers around the world without having to develop a trading relationship with the supplier, or without having to hire agents, translators, etc., to develop the supplier contacts and conduct the negotiation. Alternatively, the buyer may specify which supplier(s) should receive the RFQ. In such case, the transaction server subsystem would only transmit the RFQ to the suppliers named by the buyer. As used herein, the term supplier includes product manufacturers as well as manufacturer representatives, resellers, etc.

The RFQ's are received by the supplier terminals for display to the supplier. Preferably, the supplier may selectively view either a summary or a full listing of the RFQ to determine whether the supplier wishes to place a bid. Disinterested suppliers may simply delete or ignore the RFQ. Interested suppliers may prepare a quote or bid for presentation to the buyer. In the exemplary embodiment, the bid is developed through the supplier terminal for transmission to the buyer terminal via the transaction facilitator. Alternatively, the supplier may prepare the bid conventionally for transmission via fax, mail, hand delivery, etc.

A supplier's bid will typically correspond to the product description of the RFQ. The bid will also include the price at which the supplier is willing to supply the product and, optionally, a date after which the bid will expire. Alternatively, the bid may vary the components of the product description for consideration by the buyer. For example, the supplier may offer to supply the product in different sized packaging or with different shipping terms than specified by the buyer. In any event, once the bid is prepared, the supplier may transmit the bid to the transaction server subsystem for presentation to the buyer. Typically, each bid will include an indicator to identify which RFQ the bid is responsive to.

Preferably, the transaction server subsystem includes a quote module configured to receive the quotes or bids from a plurality of member suppliers, and to store the bids in a quote database. The transaction server subsystem sends the bids to the corresponding buyer either individually as the bids are transmitted by the suppliers, or collectively at predetermined times. Alternatively, the transaction server subsystem may transmit a message to the buyer indicating that a new bid has been received and is ready for review by the buyer.

The buyer terminals are configured to display the received bid(s) to the buyer. Because the RFQ and bids use standardized product-quality terms, the buyer is able to compare multiple bids fairly and objectively. After viewing a bid, the buyer may reject it expressly, allow it to expire without reply, accept the bid, or issue a counter-offer to the supplier. If the buyer rejects the bid expressly, the transaction facilitator may send a notification to the supplier that the bid has been rejected. Suppliers with rejected bids may elect to post their bids on the trading floor described above so that other buyers may review the bids.

If a counter-offer is made, it is transmitted to the transaction facilitator for presentation to the supplier. The supplier may then accept the counter-offer, reject it, or issue another counter-offer. This negotiation process may continue until the buyer has reached agreement with a supplier.

Once the buyer accepts the supplier's bid or counter-offer, an acceptance is transmitted to the supplier and the transaction proceeds toward completion. Depending on the rules agreed to by the buyer and supplier at registration, as well as on governing law, the acceptance may constitute a legally binding contract, or merely an understanding as to the terms of a contract into which the parties may enter. Additionally, system 100 preferably includes market mechanisms to discourage members from breaching an agreement. For example, the transaction facilitator may include a member review database where members can post comments regarding prior dealings. The comments would then be accessible to other members for review.

In any case, the transaction facilitator preferably also includes a database 115 of standard legal forms, purchase orders, invoices, shipping labels, etc., which the parties can use to complete the transaction. For example, the buyer may access the database to create a purchase order. The transaction facilitator preferably transmits to the buyer a standardized purchase order which incorporates the terms and conditions agreed to by the parties. The buyer may then edit the purchase order as needed and send it to the supplier, either via the transaction facilitator or via mail, fax, etc.

With the approval of the buyer and supplier, the transaction facilitator may publish the completed agreement in a database 115, for display to the third-party service provider members on their remote terminals. Alternatively, the buyer or supplier may access the third-party service provider registration database 115 to search for third-party members capable of providing needed services. In either case, the third-party members may then submit bids to the buyer and/or supplier to provide services necessary to execute the agreement.

By publishing the buyer/supplier agreements and enabling the third-party members to bid on providing services, system 100 ensures the buyer and supplier easy access to an existing market that might otherwise be difficult to identify. This may especially be true where the third-party members are located in different countries than the buyer or supplier. Furthermore, the buyer or supplier is able to save the typical mark-up applied when such services are arranged by one or more intermediaries, as occurs in conventional trading systems.

As described in detail above, the computer network interconnection of the transaction facilitator with the remote terminals of buyers, suppliers, and third-party service providers, allows the establishment of a global, virtual marketplace for negotiating and executing sales of goods and services. By allowing buyers to communicate directly with suppliers rather than through intermediaries, the transaction costs associated with international trades can be minimized, thereby increasing the efficiency of the market. In addition, the transaction facilitator also functions to automate the product purchasing process by electronically exchanging and supplying the necessary documentation, certifications, communications, and etc.

To further reduce the inefficiencies of conventional product markets, system 100 also establishes standardized rating systems for describing products, as well as for describing suppliers' factories. Through these rating systems, buyers can precisely specify the product they are purchasing, as well as fairly compare both the products and factories of competing suppliers. The product rating system will be described first.

As mentioned above, the food product description database 115 of the exemplary embodiment contains, for each food product, a list of food product quality characteristics which define various subjective aspects of the product. For example, most food products will be evaluated based on subjective characteristics common to all food products such as flavor, i.e., sweetness, saltiness, spiciness, etc. In addition, many food products will also be evaluated based on quality characteristics that are more or less unique to that product, such as thickness for ketchup, and the proportion of scales in canned tuna.

Some of these characteristics can be accurately measured with instruments. For example, a brix spectometer is an instrument that accurately measures the sweetness level of a product. A product rated 18% brix is sweeter than one rated 14%. For characteristics which can be accurately measured, it is possible to establish product specifications consisting of a range of measured values (e.g., a brix level of 15%-25%). Other characteristics (e.g., aroma) remain difficult to quantify and typically are evaluated based on an inspector's opinion in light of prevailing industry standards.

Thus, to allow buyers and suppliers to fully describe the food products using mutually understood, objectively quantifiable terms, system 100 establishes a database of commonly specified product-quality characteristics for each product, and then creates a standardized rating system to objectively describe relative evaluations for each characteristic. The list of product characteristics as well as the components of the product configuration can be established in a variety of ways. For example, the system operator can create the components as a complete list prior to placing the system in operation.

Alternatively, the product components can be defined dynamically based on the inputs presented by initial buyers and suppliers. As RFQ's and bids are communicated to the system, they are analyzed to identify product description components which have not previously been specified with the particular product. Thus, initial members may define their product descriptions using their own product characteristics and configurations. When the registrants use new components to create their product descriptions, those new components are added to the database. The components are then available for subsequent buyers and suppliers to create their own product descriptions. For example, the process may work as follows:

Supplier 1 Registers to sell Canned Tuna products and describes the product to be sold as follows:

| | |
|---|---|
| Configuration 1: | 6 oz Chunk Light Tuna in Water |
| Specification 1: | Less than 35% flakes |
| Specification 2: | Chunks: 65% and above |
| Specification 3: | Blood Meat - Max. 1 piece of ¼″ per can |
| Specification 4: | Scales - Max. 1 soft piece of ¼″ per can |
| Specification 5: | Bones - Max of 1 soft bone under ½″ |

Supplier 2 Registers to sell Canned Tuna products and describes the product to be sold as follows:

| | |
|---|---|
| Configuration 1: | 6-1/8 oz Chunk Light Tuna in Water |
| Specification 1: | Less than 30% flakes |
| Specification 2: | Chunks: 70% and above |
| Specification 3: | Chunks = Piece of ½″ to 1-1/2″ |
| Specification 4: | Blood Meat - Max. 1 piece of ¼″ per can |
| Specification 5: | Scales - Max. 1 soft piece of ¼″ per can |
| Specification 6: | Bones - Max. of 1 soft bone under ½″ |

Buyer 1 sends a Request for Quotation which describes the product to be purchased as follows:

| | |
|---|---|
| Configuration 1: | 6 oz Chunk White Tuna in Water |
| Specification 1: | Less than 25% flakes |
| Specification 2: | Chunks: 75% and above |
| Specification 3: | Chunks = Piece of ¾″ to 1-1/2″ |
| Specification 4: | Blood Meat - Max. 1 piece of 3/8″ per can |
| Specification 5: | Scales - Max. 1 soft piece of ¼″ per can |
| Specification 6: | Bones - Max. of 1 soft bone under 3/8″ |
| Specification 7: | Flavor - Fishy but no other off flavors |
| Specification 8: | Color - Light Brown characteristic of Skipjack tuna |
| Specification 9: | Min Pressed weight: 95.5 grams |
| Specification 10: | Vacuum over 1″ |

The three product descriptions above will result in a standard component list for canned tuna as follows:

| | |
|---|---|
| Configuration: | 6 oz Chunk Light in Water |
| Configuration: | 6-1/8 oz Chunk Light Tuna in Water |
| Configuration: | 6 oz Chunk White Tuna in Water |
| Specification: | Min Pressed weight: 95.5 grams |
| Specification: | Vacuum over 1″ |
| Specification: | Less than 25% flakes |
| Specification: | Less than 30% flakes |
| Specification: | Less than 35% flakes |
| Specification: | Chunks: 65% and above |
| Specification: | Chunks: 70% and above |
| Specification: | Chunks: 75% and above |
| Specification: | Chunks = Piece of ½″ to 1-1/2″ |
| Specification: | Chunks = Piece of ¾″ to 1-1/2″ |
| Specification: | Blood Meat - Max. 1 piece of ¼″ per can |
| Specification: | Blood Meat - Max. 1 piece of 3/8″ per can |
| Specification: | Scales - Max. 1 soft piece of ¼″ per can |
| Specification: | Bones - Max. of 1 soft bone under ½″ |
| Specification: | Bones - Max. of 1 soft bone under 3/8″ |
| Specification: | Flavor - Fishy but no other off flavors |
| Specification: | Color - Light Brown characteristic of Skipjack tuna |

Subsequent buyers and suppliers are able to select from this list of components to create their product description. Thus, at least initially, the database is self-populating. As more components are added to the list, virtually all possible specifications and configurations of a product are identified and selectable by buyers and suppliers to describe the products they wish to trade. Additionally, once a comprehensive list of components is created for a particular food product, a set of “standard” components may be identified by the system operator. These standard components may then be designated as the only recognized components of a product description for a particular product. Alternatively, the standard components may be designated as a “suggested” list of components only, so that new components may be defined by buyers and suppliers as needed.

Under the standardized rating system of the invention, each characteristic is defined to vary across a numerical range. In addition, an overall quality rating is also defined for the product to provide an objective indication of total product-quality. Using the overall product rating, buyers and suppliers are able to compare the relative values of food products from different factories where the products of one factory have a relatively higher rating for some characteristics and a relatively lower rating for other characteristics.

In the exemplary embodiment, the numerical range 1-5 is used for the individual product characteristics ratings as well as the overall rating. It will be appreciated that other numerical ranges could also be used, and that non-numerical ranges (e.g., A, B, C, D, E, . . . ) may be used in place of numerical ranges.

In the case of the overall rating, the 1-5 rating range corresponds to generic quality levels:

5=Excellent quality;

4=Superior quality;

3=Average quality (meets desired minimum quality standards);

2=Inferior quality (sub standard);

1=Significantly inferior quality (substantially below standard).

In the case of the individual product characteristics, the 1-5 rating range corresponds to generally accepted levels of quality for each particular characteristic, and will be individually defined for each characteristic. For example, relevant characteristics for the product “canned tuna” might include: tuna species, color target for the meat, chunk identity, percentage of flakes allowed, turbidity of packing liquid, aroma/odor, flavor, texture, saltiness, acceptable maximum cleaning defects allowed, etc. Table 1 is an exemplary list of product characteristics and ratings for canned tuna. Database 115 contain similar lists for each food product.

TABLE 1
RATING EXPLANATION (48/6 oz Chunk Light Tuna in Water)

| | |
|---|---|
| 5 | EXCELLENT QUALITY - |
| 4 | SUPERIOR QUALITY - |
| 3 | AVERAGE QUALITY - |
| 2 | INFERIOR QUALITY - |
| 1 | SIGNIFICANTLY INFERIOR QUALITY - |

Color: (Characteristic of Color normally associated with
the Specie - Munsell)

| | Yellowfin | Skipjack |
|---|---|---|
| 5 | Light creamish color or | Light creamish color or |
| | light pinkish tone | light pinkish tone |
| 4 | Beige to light brown | Beige to light brown |
| 3 | Light brown tones | Light brown tones |
| 2 | Dark-brown and/or green cast | Grey/green or caramelized |
| | | with yellowish cast |
| 1 | Dark, mahogany and/or purple | Dark, mahogany and/or purple |

Chunk Identity: (Chunks of 1/2″ to 1-1/2″ with flakes not exceeding 35%)

| | |
|---|---|
| 5 | More than 75% of content = Chunks >1/2″ |
| 4 | 70% to 75% of content = Chunks >1/2″ |
| 3 | 65% to 70% of content = Chunks >1/2″ |
| 2 | 50% to 65% of content = Chunks >1/2″ |
| 1 | Less than 50% of content = Chunks >1/2″ |

Percentage of Flakes (Flakes defined as small pieces smaller than
1/2″ in any direction)

| | |
|---|---|
| 5 | Less than 25% of content = Flakes (<1/2″) |
| 4 | 25% to 30% of content = Flakes (<1/2″) |
| 3 | 30% to 35% of content = Flakes (<1/2″) |
| 2 | 35% to 50% of can = Flakes (<1/2″) |
| 1 | Greater than 50% of can = Flakes (<1/2″) |

Overall Appearance: (First Visual impression as the can is opened)
(Takes into account: Surface appearance, scorching, cloudiness of
Hydrolyzed protein (HP), cake surface flakes, etc.)

| | |
|---|---|
| 5 | Slight cloudiness of liquid, minimal surface flakes (<15%), |
| | Chunks visible |
| 4 | Slightly milky liquid, minimal surface flakes (<35%), chunks visible |
| 3 | Milky liquid, surface flakes (+/−50%), Chunks partly hidden |
| | by flakes |
| 2 | Milky liquid, significant surface flakes (+/−65%), Chunks completely |
| | hidden by flakes |
| 1 | Jelling of HP, significant surface flakes (+/−60%), Chunks |
| | completely hidden by flakes |

Turbidity: (Clarity of liquid with hydrolyzed protein)

| | |
|---|---|
| 5 | Slight cloudiness of liquid typical of Hydrolyzed protein |
| 4 | Slightly milky appearance of liquid typical of Hydrolyzed protein |
| 3 | Milky liquid typical of Hydrolyzed protein |
| 2 | Unusually milky liquid with excessive fish fibers floating in the liquid |
| 1 | Unusually milky appearance, jelling of HP and fish fibers floating |
| | in liquid |

Aroma: (Subjective evaluation - Must be characteristic of good quality
canned tuna)

| | |
|---|---|
| 5 | Characteristic of canned tuna specie. No off odors |
| 4 | Slight fishy odor, but normal for canned tuna. No off odors |
| 3 | Stronger off odor (fishy or scorched), but still acceptable. |
| | No off odors |
| 2 | Strong fishy odor indicating possible processing oxidation or |
| | rancidity, or strong off odor |
| 1 | Unacceptable fish taste and/or off odor |

Flavor: (Subjective evaluation - Must be characteristic of good quality
canned tuna)

| | |
|---|---|
| 5 | No fishy or off flavors |
| 4 | Slight fishy flavor but no other off flavors |
| 3 | Fishy flavor but no other off flavors |
| 2 | Strong fishy flavor and/or off flavors |
| 1 | Very strong fishy flavor and/or other possible off flavors |

Texture: (Indicative of consistent process - measures uniformity of
tenderness and juiciness)

| | |
|---|---|
| 5 | Uniformly tender, juicy & meaty |
| 4 | Some variability - some chunks softer than others |
| 3 | Acceptable but with little uniformity |
| 2 | Nor?? uniform, soft, mushy and/or overcooked product |
| 1 | Rubbery, dry, excessively soft or mushy. Possibly overcooked |

Saltiness: (Lab test to measure range)

| | |
|---|---|
| 5 | Range of 1.0% to 1.4% |
| 4 | Range of 0.8% to 1.6% |
| 3 | Range of 0.4% to 1.6% - Note: Normal fish is usually 0.4% with |
| | no salt added |
| 2 | Range of 0% to 0.8% on low side OR 1.6\hat{ } to 2.2% on high side |
| 1 | Any reading over 2.2% |

Cleaning Defects - Skin

| | |
|---|---|
| 5 | No defects whatsoever |
| 4 | 1 piece of less than 1/8″ |
| 3 | 1 piece of less than 1/4″ |
| 2 | 1 piece greater than 1/4″ |
| 1 | More than 1 piece, and greater than 1/4″ |

Cleaning Defects - Scales

| | |
|---|---|
| 5 | No defects whatsoever |
| 4 | 1 piece of less than 1/8″ |
| 3 | 1 piece of less than 1/4″ |
| 2 | 1 piece greater than 1/4″ |
| 1 | More than 1 piece, and greater than 1/4″ |

Cleaning Defects - Bones

| | |
|---|---|
| 5 | No defects whatsoever |
| 4 | 1 piece of less than 1/4″ (soft bone only) |
| 3 | 1 piece of less than 1/2″ (soft bone only) |
| 2 | 1 piece greater than 1/2″ (soft bone only) |
| 1 | More than 1 piece, and greater than 1/2″ and/or hard bone |

Cleaning Defects - Blood Meat
Meat containing vascular tissue normally used in cat food (different from
dark meat)

| | |
|---|---|
| 5 | No defects whatsoever |
| 4 | 1 piece of less than 1/8″ |
| 3 | 1 piece of less than 1/4″ |
| 2 | 1 piece greater than 1/4″ |
| 1 | More than 1 piece, and greater than 1/4″ |

Retort Defects - Surface scorching due to Jumbled retorting

| | |
|---|---|
| 5 | Range of 0″ to 1/2″of surface scorching in all 4 cans combined |
| 4 | Range of 1/2″ to 1″ of surface scorching in all 4 cans combined |
| 3 | Range of 1″ to 2″ of surface scorching in all 4 cans combined |
| 2 | Range of 2″ to 3″ of surface scorching in all 4 cans combined |
| 1 | Surface scorching in all 4 cans exceeding a combined total of 3″ |

Buyers define their product configurations based on their needs. The same is true for their product specifications. When a buyer is defining an RFQ, the transaction server subsystem typically presents the list of product-quality characteristics after the buyer selects a product to purchase. The buyer may then select the desired minimum rating for each characteristic. In addition, the buyer may select an overall quality rating. These selections form the product specification portion of the RFQ.

In contrast to buyers, suppliers define their product configurations based on their ability to supply particular product configurations. Furthermore, as discussed in more detailed below, suppliers define their product specifications based on the results of quality-control evaluations performed on a statistical sampling of their products. The purpose of the evaluations is to apply ratings from the standardized rating system to each product characteristic. Thus, buyers are assured that the products they purchase meet or exceed the level of quality they specify.

In addition to creating a database of product description components by capturing the product configurations and specifications of initial transactions, the system is also preferably configured to develop minimum product-quality standards by capturing the specified product characteristic ratings transmitted in buyers' RFQ's and suppliers' bids. Once a substantial number of RFQ's or bids are submitted to the transaction facilitator, the system can build a profile defining what most buyers and suppliers consider to be minimally acceptable levels of quality. Further, the system is also preferably configured to incorporate any applicable industry or governmental regulations (e.g., U.S. Food and Drug Administration, U.S. Department of Agriculture, Dairy Association, etc.). By merging the profile with the regulations, the system can establish minimum standards for product quality. These minimum product-quality standards further assist buyers and suppliers to evaluate products.

In the exemplary embodiment, product testing is carried out by an independent quality-control monitoring organization. For each product, the transaction facilitator develops a testing protocol specifying what tests should be performed on the product. The testing protocol includes tests for each recognized product characteristic, and may include physical/organoleptic tests, biological tests, chemical tests, and etc. In addition, the testing protocol also includes any additional tests needed to verify that the product meets all minimum product-quality standards. The transaction facilitator preferably sends the testing protocol to the quality-control monitoring organization via the computer network 114. In any event, the testing laboratories 132 have the capability to evaluate product samples in accordance with the testing protocol supplied by the transaction facilitator.

Preferably, suppliers periodically submit samples of their products to the testing laboratories for analysis. In the exemplary embodiment, the transaction facilitator determines when evaluations should be made and instructs the supplier to send product samples to the quality-control monitoring organization. Additionally, the transaction facilitator determines which laboratory will perform the tests and transmits mailing labels, etc., to assist the supplier. The transaction facilitator also transmits a notice to the selected testing laboratory for test scheduling.

The testing laboratories conduct the tests specified in the testing protocol and apply the standardized ratings in accordance with the rating system. The testing laboratories preferably evaluate a sufficient number and distribution of the products to constitute a statistically valid sample of the product population. The results of the product evaluations are then transmitted to the transaction facilitator in a quality-control report or similar format. The product ratings applied by the testing laboratories may then be incorporated into the suppliers' bids. In addition, the entire quality-control report may optionally be presented to the buyer along with the bid. Thus, the product characteristics provided in bids from suppliers define the actual quality of the supplier's products as verified by an independent organization.

Preferably, the transaction facilitator maintains a database 115 containing the results of quality-control tests for each supplier over an extended period of time. From the information in this database, a trend analysis can be developed showing how the quality of the supplier's product(s) has changed over time. This may give buyers a more representative view of the supplier's capabilities than would a single set of tests.

As discussed above, each product is evaluated and given a component rating for each characteristic measured, as well as an overall product quality rating. Typically, however, different buyers will have different priorities when evaluating the various quality characteristics of a food product. For example, one buyer might consider the color and general appearance of a product to be the most important component(s), while another buyer might consider some other characteristic (e.g., the proportion of flakes in cans of tuna) to be the most important. Therefore, the exemplary embodiment of system 100 provides two methods by which a buyer may designate some characteristics as being more important than others.

According to the first method, buyers may designate product characteristics as being either critical or acceptable. If a product characteristic is designated as critical, then the failure to meet or surpass the specified rating would be a critical defect. Thus, if even one unit in a sampled lot were evaluated to contain a critical defect, the entire lot would be considered rejected (at least under to that buyer's product description). Conversely, if a product characteristic is designated as acceptable, then the failure to meet or surpass the specified rating would be an acceptable defect. Thus, if one unit in a sampled lot were evaluated to contain an acceptable defect, the entire lot would not necessarily be rejected.

For example, one buyer may insist that a random sample of cans of tuna should have a zero bone tolerance level, while another buyer may accept one small soft bone per can. In the first instance, the presence of a single bone is a critical product defect that would cause the entire lot to be rejected while in the other case the presence of a single soft bone is an acceptable defect that would not cause the entire lot to be rejected. Additionally, each acceptable defect may also be defined to have a tolerance limit. For example, a buyer may decide that no more than 50% of the units in a sampled lot may have an acceptable defect. In the event more than 50% of the units in a sampled lot contain an acceptable defect, the entire lot is rejected.

According to the second method, each buyer is able to vary the relative importance of the various product characteristics by assigning a “weight” to each characteristic. Varying weights for individual characteristics will vary a product's overall rating by emphasizing or de-emphasizing the effect of a particular characteristic on the overall rating. Thus, the buyers are able to customize the rating system to reflect their individual requirements. In addition, buyers may use both acceptable/critical characteristic designations and apply weightings to the characteristics to customize the overall rating system.

Typically, a weighting system is selected to allow the weighted characteristics to be combined into a single, overall weighted rating of product quality. It will be appreciated that various weighting methods may be used. For purposes of illustration only, and without limiting the scope of the invention, two exemplary weighting methods are described below.

Method #1: after defining the product specification and designating the characteristics as establishing either an acceptable defect (AD) or a critical defect (CD), the buyer distributes a total weight of 100 among the components of the specification. For example, the product specification characteristics for canned tuna might be weighted as follows:

| Characteristic | Weight |
|---|---|
| AD: Flakes | 10 |
| AD: Chunks | 30 |
| AD: Blood Meat | 20 |
| AD: Scales | 10 |
| CD: Bones | 10 |
| AD: Flavor | 10 |
| AD: Color | 10 |
| Total = | 100 |

Method #2: after defining the product specification and designating the characteristics as establishing either an acceptable defect (AD) or a critical defect (CD), the buyer indicates the relative importance of each component on a scale of 1 to 5, with 5 being extremely important and 1 being relatively unimportant. For example, the product specification characteristics for canned tuna might be weighted as follows:

| Characteristic | Weight |
|---|---|
| AD: Flakes | 4 |
| AD: Chunks | 5 |
| AD: Blood Meat | 4 |
| AD: Scales | 3 |
| CD: Bones | 3 |
| AD: Flavor | 3 |
| AD: Color | 2 |
| Total = | 24 |

Using either method, the customized overall quality rating of a sampled unit or lot may be determined. First, as described above, each component of the specification is tested in accordance with the pre-defined rating system (e.g., the 1-5 numerical range) to determine individual component ratings (CR). These component ratings form the component result.

The formula for numerical rating is thus defined as follows: Multiply each Component Rating (CR) by their respective Weights (W) to obtain a Weighted Component Value (WCV). Add all WCVs to obtain the Total WCV (TWCV). Add the total of all CR's to obtain the Total Component Rating (TCR). Divide TWCV by TCR to obtain the final Composite Rating for Individual Sample (CRIS). Where several product samples are tested together the CRIS values for all of the samples may be averaged together to determine the Composite Rating for the Entire Lot (CREL). The formula, in mathematical notation, is as follows:

CRᵢ*Wᵢ=WCVᵢ

WCV₁+WCV₂+ . . . WCVₙ=TWCV

CR₁+CR2+ . . . CRₙ=TCR

$$\frac{TWCV}{TCR} = CRIS$$

$$\frac{{CRIS}_{1} + {CRIS}_{2} + … {CRIS}_{n}}{n} = CREL$$

In the exemplary quality-control report depicted in FIG. 3, the CRIS for can #1 was 4.57, can #2 was 4.53, can #3 was 4.58, and can #4 was 4.43. The CREL for the entire lot was 4.53 on a scale of 1.0 to 5.0. Note that the CREL value for a first buyer may be different than the CREL value for a second buyer because the second buyer may have assigned different weightings to each component. Thus, one lot may be acceptable to the first buyer, but not to the second buyer, because each buyer is allowed to vary the significance of individual quality characteristics in determining overall product quality.

Turning now to the factory rating system, the quality-control monitoring organization includes factory inspectors 134 trained to visit and inspect or audit supplier factories. The results of these audits are then accessible to all buyers, thereby relieving both buyers and suppliers from the cost of redundant, individual audits. The factory audits preferably measure a wide variety of quality criteria corresponding to applicable regulations as well as industry standards. Such criteria may include various measurements of cleanliness, employee training and practices, maintenance practices, and etc. In the exemplary embodiment, the trade facilitator schedules factory audits and sends a notice to both the supplier and the quality-control monitoring organization via the Internet.

An exemplary audit worksheet is depicted below in Table 2.

TABLE 2
PhF Specialists, Inc.
Food Safety Audit Form

Plant:
Auditor(s):
Date of Audit:

Rating Scale: 4: Excellent 3: Good 2: Fair 1: Poor

| | Rating/Comments |
|---|---|
| Premises | |

Building and grounds are neat and orderly, free of
litter and debris.
The area surrounding the plant has adequate drainage
to prevent standing water.
Vegetation is controlled to prevent pest harborage.
The roof of the building is in good repair, free of
leaks, debris and standing water.

Building Interior - Design, Construction, Maintenance

Floors, walls and ceilings are smooth, cleanable and
well maintained.
All floors, walls doors and windows are properly
sealed.
There is no chipped or peeling paint, rust, etc. on
floors, walls.
Traffic patterns are controlled to prevent cross-
contamination between raw and finished product.

Building Interior - Lighting

Lighting is adequate.
Light bulbs and fixtures are covered to prevent
contamination in the event of breakage.

Building Interior - Ventilation

Ventilation in the facility is adequate.

Building Interior - Waste Disposal

Drainage an sewage systems are equipped with
appropriate traps and vents.
Floor drains are adequate.
Waste containers are clearly identified, leak-proof,
and covered.
Waste is removed and containers are cleaned and
sanitized at appropriate intervals.

Employee Facilities

Toilet facilities have no direct access to food areas.
Toilet facilities have hot and cold running water,
adequate supplies (soap, sanitizer, sanitary hand
drying equipment).
Toilet facilities, locker rooms and eating areas have
adequate floor drainage, waste receptacles, and are
clean and well maintained.
Handwashing notices are posted in appropriate
areas.

Water, Steam Supply

Water is potable and analyzed at a frequency
adequate to ensure potability.
All hoses, taps, etc. are designed to prevent backflow
or back-siphonage.
The volume pressure and temperature of water is
adequate for all production and clean-up requirements.
The steam supply is generated from potable water and
is adequate to meet operational requirements.

Transportation

There is a program from inbound/outbound truck and
trailer inspection.
Trucks are loaded, arranged and unloaded to prevent
damage an contamination of product and packaging
materials.

Receiving

Incoming materials are received in an area separate
from the processing area.
Procedures for acceptance of ingredients and
materials are followed.
Ingredients and packaging materials are handled
and stored to prevent damage and contamination.

Storage

When required, ingredients and packaging material
is used on a first-in/first-out basis.
Finished product is properly coded.
Finished product case codes are legible and allow
for tracability in the event of a recall.
Temperature control is adequate for ingredients and
finished products.
Pallets are in good condition and clean.
Finished product is stored and handled to prevent
damage (stacking height, forklift damage).
There is at least an 18″ perimeter maintained
throughout the warehouse.

Chemical Storage/Handling

Chemicals are received and stored in a dry, well-
ventilated area.
Non-food chemicals are stored in designated areas
so there is no possibility of cross-contamination of
food or food contact surfaces.
Chemicals are stored and mixed in clean, labeled
containers.
Chemicals are dispensed and handled only by
authorized personnel.
Chemical control procedures are present for non-
food ingredients that address purchase, storage,
labeling, use, container disposal, MSDS and
employee training.

Non-conforming Product

There is adequate means to monitor conformance to
requirements for weight control, volume standards,
color, size, shape, etc.
Defective ingredients, packaging materials and
finished product are clearly identified and segregated.

Equipment/Utensils

Equipment is designed and installed so it is easily
accessible for cleaning. Utensils are easily
cleanable, properly stored.
Equipment and utensils are designed to prevent
product contamination (no uncovered screws, etc.)
and are constructed of appropriate materials.
Equipment and utensils are well maintained, with
no excess lubrication, flaking paint, rust, etc.

Maintenance/Repair and Calibration

There is a written preventive maintenance program,
and maintenance records for all equipment
maintenance and repair.
Thermometers, scales, etc. are calibrated at a
sufficient frequency to assure accuracy and met
regulatory requirements. Calibrations are
performed by authorized personnel.
Calibration records (date of calibration, equipment,
name of technician, results of calibration) are kept.

Foreign Matter

All processing, raw material and finished product
areas are free of unprotected glass.
There are adequate controls - sorting, filters,
screens, etc. - to remove foreign matter.

Sanitation

Employees conduction cleaning and sanitizing are
properly trained.
Cleaning and sanitizing agents are used properly
and are of the proper concentration for their use.
Cleaning schedules and practices are designed to
prevent contamination of product, packaging
materials or manufacturing lines that may be
operational during the cleaning process.
Equipment and utensils are properly cleaned and
sanitized (no product residues, mold, etc.)
Sanitation records include the date, responsible
employee, findings corrective actions and
microbiological results (if applicable).

Pest Control

There is no evidence of pest activity which could
contaminate product, packaging or equipment.
There is an organized pest control program.
There is a log which includes: target pest,
pesticides, used, method and dates of application,
applicator's name, etc.
All pest control devices are located so they cannot
contaminate product, packaging or equipment; pest
control devices are properly maintained.

Personnel

All workers wash/sanitize hands before starting
work, when entering food handling areas, when
hands become unclean, after breaks, using toilets,
and other required intervals.
Signs regarding handwashing are conspicuously
posted.
Workers do not eat, drink, smoke, chew gum, etc.,
except in designated areas.
Workers do not wear jewelry, nail polish, fake
fingernails, etc., in the processing area. Where
required, protective clothing (hair nets, beard nets,
gloves, uniforms) are worn.
Uniforms are clean and well maintained.
Personal belongings are stored in appropriate locations.
Visitors are required to follow the same rules as
employees when in the plant.

Disease Control

The disease control policy is conspicuously posted.

Training

All workers are adequately trained in personal
hygiene and food handling.
Workers receive adequate technical training to
understand and perform their jobs.
GMP Programs
There should be a complete written program for each of
the items listed below.

Sanitation Program

Worker sanitation: Requirements for
washing/sanitizing hands, sanitizer concentration
requirements.
Equipment sanitation: Requirements for
cleaning/sanitizing equipment and utensils,
including frequency, procedures, sanitizer
concentration, person responsible for program.

Employee Hygiene

Disease control policy to prevent workers who have
illness, infection or open wounds from handling
food or food packaging materials.

Pest Control

Inspection forms, floor plans/maps with location of
bait & traps, equipment manuals, pesticide labeling,
safety data, type and frequency of inspections to
verify effectiveness of program, name of employee
responsible for program.

Glass Policy

Identification of all potential hazards and how they
are controlled, prohibition of unprotected glass in
the facility, procedures for handling and reporting
broken glass, changing light bulbs, disposing of
glass.

Chemical Control

Identification of all hazardous chemicals used at the
facility, list of workers who have access to
chemicals, procedures for receipt, storage and use
of hazardous chemicals.

Transportation

Procedures for inspection of carriers upon receipt
and prior to loading to ensure they are free of
contamination and suitable for their intended use,
procedures for loading and unloading to minimize
damage.

Incoming Ingredients

Procedure for ingredient supplier approval, current
list of approved suppliers, procedure for receipt of
ingredients and rejection of damaged/out of
specification ingredients, procedure for rotation of
ingredients to prevent spoilage (if necessary).

Water Analysis

Type and frequency of analysis, where analysis is
conducted (lab, government, etc.), procedure if
water does not meet specifications.

Recall Program

Coding of product to allow identification in the
event of a recall, manes and phone numbers of
employees designated to handle recall of product,
interaction with regulatory agencies, brokers and
customers, procedure to determine the codes
involved in the recall and the location of recalled
codes, procedure for sending samples to a qualified
lab for analysis.

HACCP

Process flow diagram, process description, hazard
analysis, determination of CCP's. For each CCP,
critical limits, monitoring requirements, corrective
actions, verification procedures, records.

Preferably, the audit results are expressed in the form of standardized, numerical ratings corresponding to relative levels of factory quality. The completed audit worksheet may then be made accessible to buyers from a database 115. Alternatively, or additionally, an audit report may be generated either by the quality-control monitoring organization or the trade facilitator, and then presented to interested buyers. An exemplary audit report is illustrated in FIG. 4. Additionally, a standardized, overall factory rating may be developed from the individual criteria ratings, and made accessible to buyers via the trade facilitator. This overall factory rating provides a simple and reliable indication of the quality of a supplier's factory and products relative to those of other suppliers. Thus, when reviewing a bid from a supplier, the buyer may also review the supplier's factory ratings as well as product ratings to compare the supplier against competing suppliers.

In the exemplary embodiment, a newly registered supplier is permitted to submit its own factory audit information in order to begin trading until an independent audit can be arranged. In such case, the audit report is preferably labeled as unverified or unaudited, until an independent audit report is completed.

Appendixes A and B provide further details of an exemplary embodiment of the present invention. Nevertheless, it will be understood that the invention as herein described is not limited to a particular embodiment as there are numerous ways to practice the claimed invention.

The present invention may also be understood as described in the following numbered paragraphs:

I. A computer-implemented system for facilitating transactions involving the purchase of bulk, non-commodity food products, comprising:

a transaction server subsystem, including

an RFQ module configured to receive RFQ's for bulk, non-commodity food products from one or more buyers, and

a quote module configured to receive quotes for bulk, non-commodity food products from one or more suppliers,

wherein the RFQ's and the quotes include food-product-quality information;

a plurality of remote buyer terminals connectable to communicate with the transaction server subsystem, and configured to transmit RFQ's to the transaction server subsystem and view quotes received by the transaction server subsystem; and

a plurality of remote supplier terminals connectable to communicate with the transaction server subsystem, and configured to view RFQ's received by the transaction server subsystem and transmit quotes to the transaction server subsystem.

II. A method of facilitating a transaction involving the purchase of bulk, non-commodity food products, comprising:

displaying, via a computer network system, an RFQ to a plurality of food product suppliers, where the RFQ identifies a particular bulk, non-commodity food product desired by a buyer, and where the RFQ includes standardized food-product-quality characteristics selected by the buyer to specify a desired level of quality of the particular food product;

receiving, via a computer network system, at least one quote from one of the food product suppliers, where the quote identifies a bulk, non-commodity food product offered for sale by the supplier, and where the quote includes standardized food-product-quality characteristics which specify a declared level of quality of the food product offered for sale; and

presenting, via a computer network system, the quote to the buyer.

III. A method of negotiating to purchase bulk, non-commodity food products, comprising:

defining an RFQ for a bulk, non-commodity food product, including specifying one or more standardized food-product-quality characteristics;

transmitting the RFQ via a computer network for viewing by a plurality of food-product suppliers;

viewing one or more quotes transmitted via the computer network by one or more of the suppliers, wherein the quotes specify one or more standardized food-product-quality characteristics of a food product offered by the corresponding supplier; and

transmitting an acceptance of at least one of the quotes via the computer network.

IV. A method comprising the steps of:

creating a food product database in a computer system accessible by a plurality of buyers, the database containing a plurality of food product descriptions, where each food product description includes

a product configuration identifying a particular food product, and

a product specification including one or more optionally selectable, standardized ratings specifying a predefined level of quality of the identified food product;

displaying at least a portion of the food product database to a buyer for selection by the buyer of a food product for purchase;

receiving, from the buyer, an RFQ specifying at least one food product description from the database;

displaying the RFQ to one or more suppliers;

receiving one or more quotes from the suppliers in response to the RFQ; and

displaying the quotes to the buyer.

V. A virtual marketplace for negotiating sales of bulk, non-commodity food products, comprising:

a computer database;

a plurality of remote supplier terminals connected, via a computer network, to transmit offers from food product suppliers for storage on the database, the offers including offers to sell bulk, non-commodity food products;

where the database includes, for each of the plural suppliers, a supplier rating associated with the supplier, and adapted to indicate a level of quality of the food products offered for sale by the supplier relative to the food products offered for sale by the other suppliers; and

a plurality of remote buyer terminals connected to access the database via a computer network, and configured to display the offers stored on the database and the supplier ratings associated with the suppliers.

VI. A method of assuring product quality to buyers purchasing bulk, non-commodity food products over a computer network, the method comprising:

for each of a plurality of suppliers of bulk, non-commodity food products, testing at least a statistically valid sampling of the food products produced by the supplier to generate reliable, supplier-specific, quality-control information;

for each of the food product suppliers, generating a quote to supply a desired quantity of a food product, each quote including the corresponding supplier-specific, quality-control information;

transmitting the quote from each of the food product suppliers onto a computer network; and

on a computer connectable to the network, displaying the quote from each of the food product suppliers for review by a food product buyer.

VII. A method of marketing food products over a computer network, comprising:

providing a plurality of independent, food product suppliers connected to the computer network to submit quotes for supplying food products to one or more buyers;

providing a quality-control monitoring organization capable of measuring one or more selected quality-characteristics of a food product;

creating a quality-control report for each of the plural food product suppliers by

selecting a statistically valid sample of the food products produced by the supplier, and

measuring at least one selected quality-characteristic of each food product in the sample,

where the step of measuring is carried out by the monitoring organization;

receiving, via the computer network, a quote for supplying a food product from a first one of the plural suppliers; and

presenting to at least one of the buyers via the computer network,

the quote received from the first supplier, and

the quality-control report corresponding to the first supplier.

Appendix C describes a further feature of the present invention, namely an automated, portable, factory audit device. As detailed more fully in Appendix C, the audit device is a computer-controlled device configured to allow an inspector to enter factory audit information into electronic storage in the device. Further, the device prompts the inspector through the audit process. The device is connectable to the trade facilitator or the user terminal of the quality-control monitoring organization, via computer network 114 or other means of electrical connection. It will be appreciated, however, that the automated audit device is not required to conduct the factory auditing described above.

While the invention has been disclosed in its preferred form, the specific embodiments thereof as disclosed and illustrated herein are not to be considered in a limiting sense as numerous variations are possible. Applicants regard the subject matter of their invention to include all novel and non-obvious combinations and subcombinations of the various elements, features, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are broader, narrower or equal in scope to the original claims, are also regarded as included within the subject matter of applicants' invention.

We claim:

1. A virtual marketplace for negotiating sales of bulk, non-commodity food products, comprising:
a plurality of remote buyers and suppliers of bulk, non-commodity food products interconnected via an international computer network; and
on a computer connected to the network, software operable to
receive, via the network, an RFQ for a food product from a buyer,
present, via the network, the RFQ to at least some of the suppliers,
receive, via the network, one or more quotes for the food product from one or more of the suppliers, and
present, via the network, at least one of the quotes to the buyer.

2. A method of facilitating on-line transactions involving the sale of a food product having a value to a buyer determined by objective characteristics and subjective characteristics, the method comprising:
establishing a standardized rating system effective to objectively describe relative evaluations of one or more subjective characteristics of the food product;
evaluating one or more subjective characteristics of the food product in accordance with the rating system;
applying a rating from said rating system to each subjective characteristic evaluated; and
transmitting, via a computer network, at least one of
an RFQ for the food product from a buyer, where the RFQ specifies a desired subjective characteristic of the food product according to the corresponding rating of the rating system, or
a quote for the food product from a supplier, where the quote specifies a subjective characteristic of the food product according to the rating applied to the food product.

3. A method of facilitating a transaction involving the purchase of bulk, non-commodity food products, comprising:
displaying, via a computer network system, a plurality of bulk, non-commodity food products to a buyer;
receiving, via a computer network system, a selection identifying one of the food products from the buyer;
displaying, via a computer network system, a list of food-product-quality characteristics corresponding to the selected food product;
receiving, via a computer network system, a selection from the buyer identifying one or more food-product-quality characteristics from the list; and
presenting, via a computer network system, an RFQ specifying the selected food product and the selected food-product-quality characteristics to a plurality of suppliers.
